(19) United States
(12) Patent Application Publication
(10) Pub. No.: US 2013/0223611 A1
(43) Pub. Date: Aug. 29, 2013

(54) BREAK INJECTION AT WORK ASSIGNMENT ENGINE OF CONTACT CENTER

(71) Applicants: Joylee Kohler, Northglenn, CO (US); Robert C. Steiner, Broomfield, CO (US); Andrew D. Flockhart, Thornton, CO (US)

(72) Inventors: Joylee Kohler, Northglenn, CO (US); Robert C. Steiner, Broomfield, CO (US); Andrew D. Flockhart, Thornton, CO (US)

(73) Assignee: AVAYA INC., Basking Ridge, NJ (US)

(21) Appl. No.: 13/408,793

(22) Filed: Feb. 29, 2012

(51) Int. Cl. H04M 3/00

(52) U.S. Cl. 379/265.02

(57) ABSTRACT

A contact center is described along with various methods and mechanisms for administering the same. The contact center proposed herein provides the ability to, among other things, include a break-type work item in a work pool that also contains traditional work items. The break-type work item comprises attributes that enable the break-type work item to be routed to one or more resources in the contact center with a work assignment engine that routes the traditional work items.

### FIELD OF THE DISCLOSURE

The present disclosure is generally directed toward communications and more specifically toward contact centers.

### BACKGROUND

Managing staffing levels in a contact center is a difficult task. There are competing incentives to (a) keep agents as busy as possible during work hours and (b) maintain a humane work environment. Contact center supervisors often give agents breaks at predefined and staggered intervals. This helps to ensure that at least some agents are always available to handle incoming contacts at any given time.

One problem with manually administering agent breaks is that it often fails to account for the current state of the contact center (e.g., whether the contact center is experiencing a period of heavy volume or light volume). Imagine a scenario where a particular agent goes on a break and then a high volume of contacts suddenly enter the contact center. The customers may either (i) experience prolonged wait times or (ii) be routed to less proficient agents. Imagine another scenario where a group of agents need to have a quick team meeting and the same high volume of contacts suddenly enter the contact center. The problems experienced by the customer become even more pronounced.

Some attempts have been made to address the above-noted problem. As one example, U.S. Pat. No. 5,721,770 to Kohler et al., the entire contents of which are hereby incorporated herein by reference, describes an Automated Call Distribution (ACD) system that is programmable by an operator of the ACD system to automatically change the work of a call center agent to maximize the agent's productivity and to provide a variety of work balanced with “breather” time, thereby minimizing agent burn-out. Unfortunately, the mechanisms described in the '770 patent have a limited amount of flexibility and responsiveness to the changing needs of today's contact centers.

### SUMMARY

It is with respect to the above issues and other problems that the embodiments presented herein were contemplated. In particular, embodiments of the present disclosure provide an intelligent and automated mechanism that administers agent breaks.

In some embodiments, the present disclosure provides the ability to assign breaks to agents in an automated and intelligent way. Specifically, the present invention proposes a work assignment engine that is both capable of generating breaks to have attributes similar to work items (referred to as break-type work items) and route the break-type work items to agents in the contact center based on the attributes assigned to the break-type work item.

Another aspect of the present disclosure is to provide a work assignment engine which can determine a current state of the contact center (e.g., normal volume, high volume, low volume, permissible wait times being met/not met, etc.) and adjust the number of break-type work items that are generated in response thereto.

There are many advantages associated with using break-type work item rather than relying on manually-administered breaks or even the automated solutions that are currently available. As one example, the break-type work item can have attributes (e.g., processing requirements) that define the type of agent to which the break-type work item should be routed. In other words, the actual work assignment logic does not have to be varied to account for assigning breaks to agents. Rather, a break-type work item is treated exactly the same as regular work items by the work assignment logic. This not only helps with smart routing of the break-type work item, but it can also help ensure that breaks are distributed evenly.

In some embodiments, because the generation of break-type work items can vary in response to contact center state, the contact center is capable of achieving better efficiencies (e.g., because breaks can be given earlier if a lull in work is detected before a normal break time or breaks can be given later if high volumes are being experienced during normal break time). Breaks may also be injected with the intention of being routed to a particular agent that has recently handled a tough call or the like.

In some embodiments, the break-type work item can be routed to the “most deserving” agent. For example, the break-type work item may have a first attribute that defines eligible agents as those agents who have not received a break within the last two hours (or any other amount of time). This first attribute precludes the break-type work item from being assigned to a subset of agents who might have otherwise received multiple breaks before other agents received a single break. The break-type work item may then have a second attribute that causes the agent that has been working the longest without a break to be the best or most deserving agent to receive the break-type work item or the agent with the highest occupancy. Since the break-type work item is assigned based on automated rules, there is a higher likelihood that agents will be treated equally when it comes to getting breaks.

In some embodiments, the break-type work item can be reported-on much like any other type of work item in the contact center. Specifically, reports can be generated that show which agents have taken breaks (e.g., have been assigned break-type work items), how many breaks the agent is qualified for, whether union break requirements are being met, etc.

In some embodiments, the break-type work item can also be given attributes that cause the break-type work item to be assigned to a plurality of agents simultaneously, much like a traditional work item that has two or more agents initially conferenced together to handle the work item. By providing break-type work items with a “team attribute”, embodiments of the present disclosure can help intelligently coordinate a collaboration break or team activity without significantly impacting the operation of the contact center. Furthermore, the generation of a break-type work item with a team attribute may be reserved for periods when the contact center volume is low.

In some embodiments, because the break-type work item can have attributes, it may also be possible to inject break-type work items that simply relieve agents of multitasking duties (e.g., insert a break-type work item for a contact of a first type but the agent can still receive a contact of a second type).

In some embodiments, the solution proposed herein can be easily implemented in contact centers of any type because the break-type work item is treated the exact same as all other work items. In other words, the break-type work item may be placed in the work pool along with all other actual work items and it has its own target start time and target end time. These target start and/or target end times may be defined, in some embodiments, by a work force management system that is operating in cooperation with the contact center.

In accordance with at least some embodiments of the present disclosure, a method is provided which generally comprises:

generating a break-type work item having one or more attributes that enable a routing decision to be made with respect to routing the break-type work item among a plurality of resources in a contact center;

including the break-type work item in a work pool that includes work items associated with customers;

comparing the one or more attributes of the break-type work item with attributes of the plurality of resources;

selecting, based on the comparing step, a first resource from the plurality of resources to receive the break-type work item;

routing the break-type work item to the first resource, thereby forcing the first resource to take a break for a predetermined amount of time.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting pools and bitmaps that are utilized in accordance with embodiments of the present disclosure;

FIG. 3 is a block diagram depicting a data structure used in accordance with embodiments of the present disclosure;

FIG. 4 is a flow diagram depicting a method of inserting break-type work items in a work pool in accordance with embodiments of the present disclosure;

FIG. 5 is a flow diagram depicting a method of assigning work items in a contact center in accordance with embodiments of the present disclosure;

FIG. 6 is a flow diagram depicting a reporting method in accordance with embodiments of the present disclosure; and

FIG. 7 is a flow diagram depicting a method of dynamically adjusting the rate of break-type work item generation in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

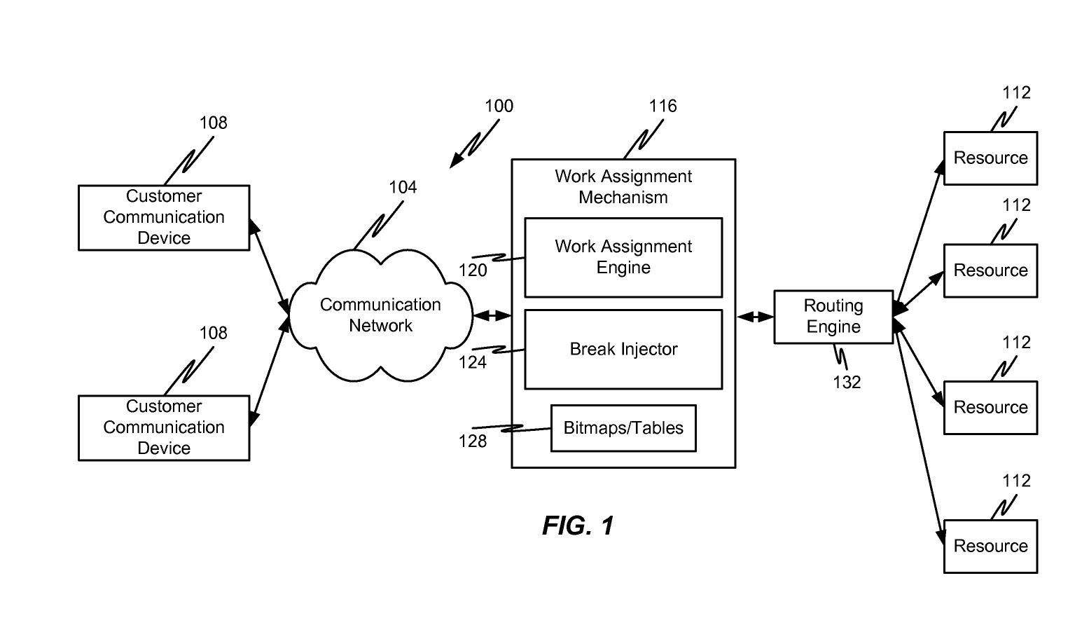

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. Moreover, as will be described in further detail herein, the work item may either correspond to a traditional type of work item or a break-type work item which forces the agent assigned thereto to take a break of a predetermined duration.

In some embodiments, work items are logical representations within a contact center of work to be performed in connection with servicing a communication received at the contact center (and more specifically the work assignment mechanism 116). On the other hand, break-type work items are logical representations within the contact center of a break to be taken by an agent that receives the break-type work item.

With respect to the traditional type of work item, the communication associated with a work item may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item (whether a work item in the traditional sense or a break-type work item) is sent toward a collection of processing resources 112 via the combined efforts of the work assignment mechanism 116 and routing engine 132. Alternatively, a break-type work item may not necessarily be routed to a resource 112, but rather may cause that resource 112 to change to a state of BUSY or UNAVAILABLE for a predetermined amount of time.

The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference.

More specifically, the work assignment engine 120 can generate bitmaps/tables 128 and determine, based on an analysis of the bitmaps/tables 128, which of the plurality of processing resources 112 is eligible and/or qualified to receive a work item and further determine which of the plurality of processing resources 112 is best suited to handle the processing needs of the work item (unless the assigned work item is a break-type work item in which case the determination of the best suited resource 112 corresponds to a most-deserving resource for the break). In situations of work item surplus, the work assignment engine 120 can also make the opposite determination (i.e., determine optimal assignment of a work item to a resource). In some embodiments, the work assignment engine 120 is configured to achieve true one-to-one matching by utilizing the bitmaps/tables 128 and any other similar type of data structure.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the work assignment mechanism 116 may also comprise a break injector 124. As discussed above, the break injector 124 may be configured to generate and inject break-type work items into a pool where other traditional work items are also maintained. The break-type work items may be routed by the work assignment engine 120 much like traditional work items. Specifically, the break injector 124 may be configured to assign one or more attributes to break-type work items which enable the break-type work items to be assigned to one or more resources 112. Advantageously, since the break-type work items are treated the same as traditional work items by the work assignment engine 120, there is no need to alter the logic of the work assignment engine 120 to accommodate the routing of break-type work items. Further still, because the break-type work items may be provided with attributes that are similar to attributes of traditional work items, the break-type work items can be distributed among the resources 112 in a fair and efficient manner.

As can be appreciated, the break injector 124 and/or bitmaps/tables 128 may be internal to the work assignment mechanism 116 or they may be separate from the work assignment mechanism 116.

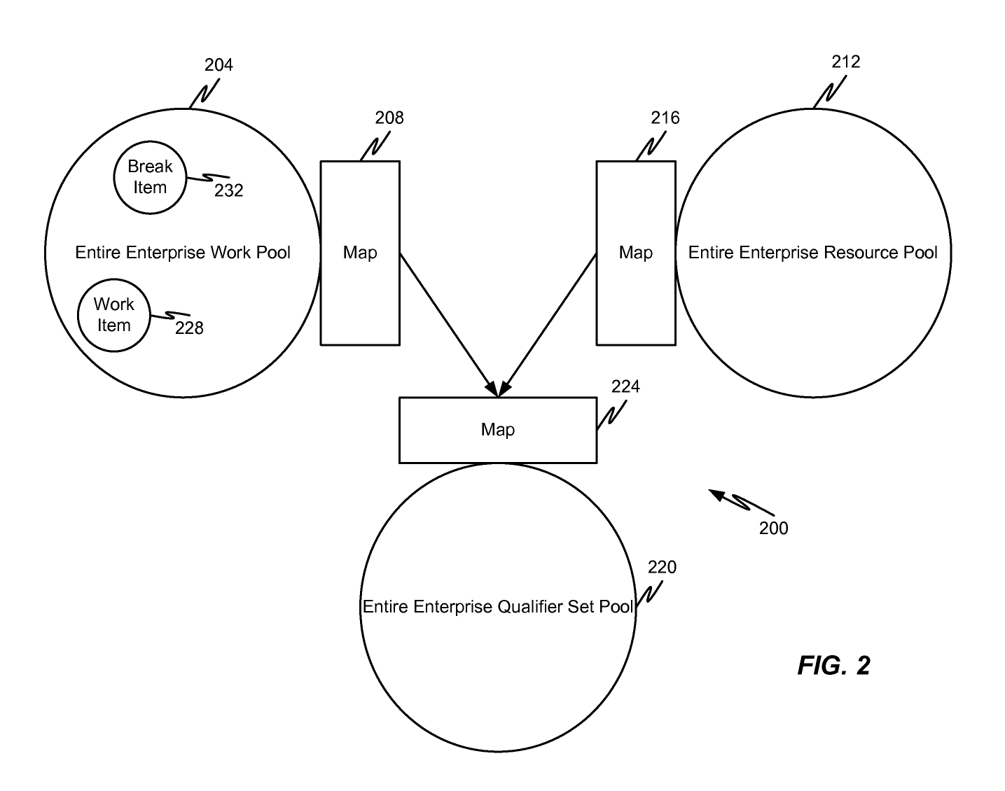

FIG. 2 depicts exemplary data structures 200 which may be incorporated in or used to generate the bitmaps/tables 128 used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item 228 and each break-type work item 232 within the contact center at any given time.

In some embodiments, the population of the work pool 204 may be limited to work items 228 and break-type work items 232 waiting for service by or assignment to a resource 112, but such a limitation does not necessarily need to be imposed. Rather, the work pool 204 may contain data instances for all work items 228 and break-type work items 232 in the contact center regardless of whether such work items are currently assigned and being serviced by a resource 112 or not. The differentiation between whether a work item 228, 232 is being serviced (i.e., is assigned to a resource 112) may simply be accounted for by altering a bit value in that work item's data instance. Alteration of such a bit value may result in the work item 228, 232 being disqualified for further assignment to another resource 112 unless and until that particular bit value is changed back to a value representing the fact that the work item 228, 232 is not assigned to a resource 112, thereby making that resource 112 eligible to receive another work item 228, 232.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item 228, 232 or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item 228, 232 in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help the work assignment engine 120 make an optimal work item/resource assignment decision based on the current state of each pool. Accordingly, the values in the bitmaps 208, 216, 224 may be recalculated each time the state of a pool changes (e.g., when a work item surplus is detected, when a resource surplus is detected, etc.).

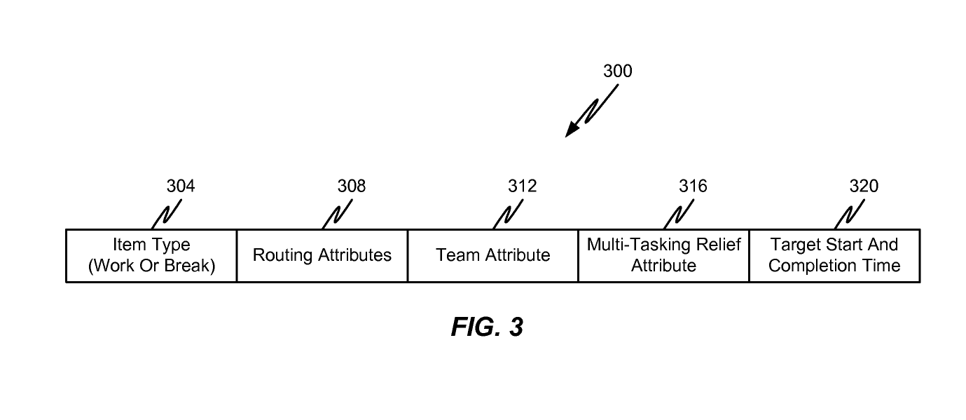

With reference now to FIG. 3, additional details of a data structure 300 used to define work items 228, 232 in the work pool 204 will be described in accordance with embodiments of the present disclosure. Specifically, each work item 228, 232 may have a corresponding data structure 300 which defines the type of work item (e.g., work or break) in an item type information field 304, how to route the work item in a routing attributes information field 308, whether to assign the work item to a plurality of resources in a team attribute information field 312, whether to provide multi-tasking relief in a multi-tasking relief attributes information field 316, and target service objectives in a service objective information field 320.

In some embodiments, the item type information field 304 may comprise one or more bits which describe whether the subject work item is a traditional work item associated with a customer contact and requiring servicing by a resource 112 or whether the work item is a break-type work item. Any type of indicator, token, or descriptor may be used to indicate whether the work item is a traditional work item or a break-type work item in the item type information field 304.

The routing attributes information field 308 may comprise data that describes the attributes of a work item, regardless of whether or not the work item is a traditional work item or a break-type work item. As noted above, the attributes of a work item 228, 232 may be in the form of one or more bits (e.g., bit values in a bitmap 208) indicating whether the work item 228, 232 has a particular attribute or not. Of course, other mechanisms of data description (e.g., strings, characters, alphanumeric values, equations, etc.) may be used to describe the attributes of a work item in the routing attributes information field 308.

The team attribute information field 312 may correspond to a separate information field as shown or it may be included in the routing attributes information field 308. In some embodiments, the team attribute information field 312 may also comprise one or more bits or bit values which identify whether a work item is to be assigned to a single resource 112 or multiple resources 112 simultaneously.

The multi-tasking relief attribute information field 316 may be similar to the team attribute information field 312 in that it too can be included in the routing attributes information field 308. In some embodiments, the multi-tasking relief attribute information field 316 may describe whether a break-type work item is to relieve an assigned resource of all work activities or only work activities for work items of a certain media type (e.g., real-time calls, real-time video calls, near-real-time Instant Message Chats, near-real-time SMS and/or MMS chats, email contacts, combinations thereof, etc.). In particular, a break-type work item 232 may be configured to relieve a resource 112 assigned thereto of all work activities and provide a complete break from work or the break-type work item 232 may simply provide a multi-tasking break. In the latter case, an agent may still be required to handle work items of media types other than those media types described in the multi-tasking relief attribute information field 316.

The service level objective information field 320 may comprise information which describes any type of service level objective or sets of objectives for work items (e.g., target start time, target completion time, maximum wait time, minimum skill requirements, duration of break time for break-type work items, etc.). It should be appreciated that the information in the service level objective information field 320 may be maintained at bit values, scalar values, or any other way of describing service level objectives for a single work item or collection of work items.

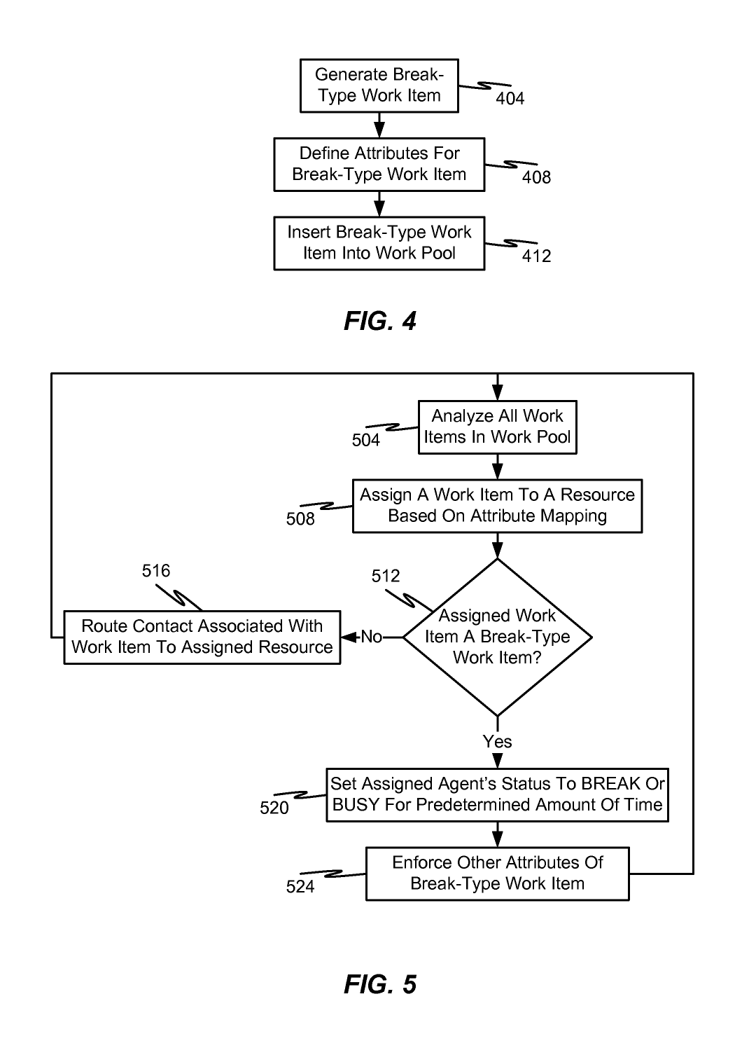

With reference now to FIG. 4, a method of inserting break-type work items in a work pool will be described in accordance with embodiments of the present disclosure. The method is initiated when the break injector 124 generates a break-type work item 232 (step 404). This step may occur automatically, in response to a predetermined amount of time passing since the last time the break injector 124 generated a break-type work item 232, in response to detecting one or more conditions or event triggers in the contact center, in response to receiving an administrative or managerial request to schedule a break or meeting, or the like.

After the break-type work item 232 has been generated, the break injector 124 defines one or more attributes for the break-type work item 232 (step 408). The one or more attributes for the break-type work item 232 may be maintained in the data structure 300, in the bitmaps/tables 128, or in any other format. In some embodiments, the one or more attributes for the break-type work item 232 describe the rules which will eventually govern how the break-type work item is assigned to one or more resources 112 in the contact center. The attributes of the break-type work item 232 may include attributes similar to attributes of a traditional work item (e.g., skill requirements, media type, etc.) as well as other attributes (e.g., team attributes, multi-tasking relief attributes, break duration, etc.).

Furthermore, the attributes for the break-type work item may relate to the desired target for the work item. Specifically, an agent may be the target of a particular work item if that agent has recently completed a difficult or very profitable work request. As another example, union or regulatory requirements may dictate that certain agent(s) are required to take a break of a predetermined duration at certain intervals during the day. The attributes used to ensure that the work item is properly routed to these types of agents may also be included in the break-type work item.

The break injector 124 then inserts the break-type work item 232 into the work pool 204 along with other work items 228 and possibly other break-type work items 232 (step 412). In some embodiments, the newly-inserted break-type work item 232 may be assigned an attribute corresponding to a time in which the break-type work item 232 entered the work pool 204 as this information may be needed later in determining whether and to whom the break-type work item 232 should be assigned (e.g., because it has been waiting for assignment in the work pool 204 longer than a predetermined amount of time). This process may repeat itself as often as is necessary.

With reference now to FIG. 5, a method of assigning work items in a contact center will be described in accordance with embodiments of the present disclosure. The method begins with the work assignment engine 120 analyzing every work item 228, 232 in the work pool 204 (step 504). In particular, the work assignment engine 120 may determine that there is a surplus of work items and/or resources and it is necessary to relieve or attempt to relieve said surplus. This step may involve doing a bitmap comparison between one or more of the bitmaps 208, 216, 224 as described above.

Based on the analysis of the work pool 204, the work assignment engine 120 identifies a first resource 112 among the plurality of resources 112 in the resource pool 212 that is “best suited” to receive a work item 228, 232 (step 508). In particular, the work assignment engine 120 may follow a process by which it first determines which resources among the plurality of resources are available/eligible to receive the work item 228, 232 and then identifies which among the available/eligible resources is best suited to have the work item 228, 232 assigned thereto. The process of identifying the best suited resource 112 may involve comparing the attributes of all eligible resources with the attributes of the work item 228, 232 being assigned and then determining which resource 112 has attributes that best match the attributes of the work item 228, 232 being assigned.

The work assignment engine 120 may then analyze the assigned work item to determine whether it corresponds to a traditional work item 228 or a break-type work item 232 (step 512). If the assigned work item is a traditional work item 228, then the work assignment engine may instruct the routing engine 132 to route the contact associated with the assigned work item 228 to the selected resource 112 (step 516). Thereafter, the method returns to step 504.

On the other hand, if the assigned work item corresponds to a break-type work item 232, then the work assignment engine 120 may simply set the selected resource(s) 112 status to BREAK, BUSY, or UNAVAILABLE for a predetermined amount of time (step 520). As can be appreciated, it may also be possible to route break-type media to the assigned resource along with the break-type work item 232 (e.g., on-hold music, entertainment, etc.). As noted above, the predetermined amount of time that the selected resource(s) 112 is on break may be defined in one or more attributes of the break-type work item 232. Any other enforceable attributes of the break-type work item 232 may also be enforced when the break-type work item 232 (step 524). Examples of such additional attributes include, without limitation, multi-tasking break attributes, team attributes, training attributes (which define training that should or can be done during the break), etc.) Thereafter, the method returns to step 504. In some embodiments, the break-type work may automatically complete itself (e.g., auto-complete) after the predetermined amount of break time has elapsed.

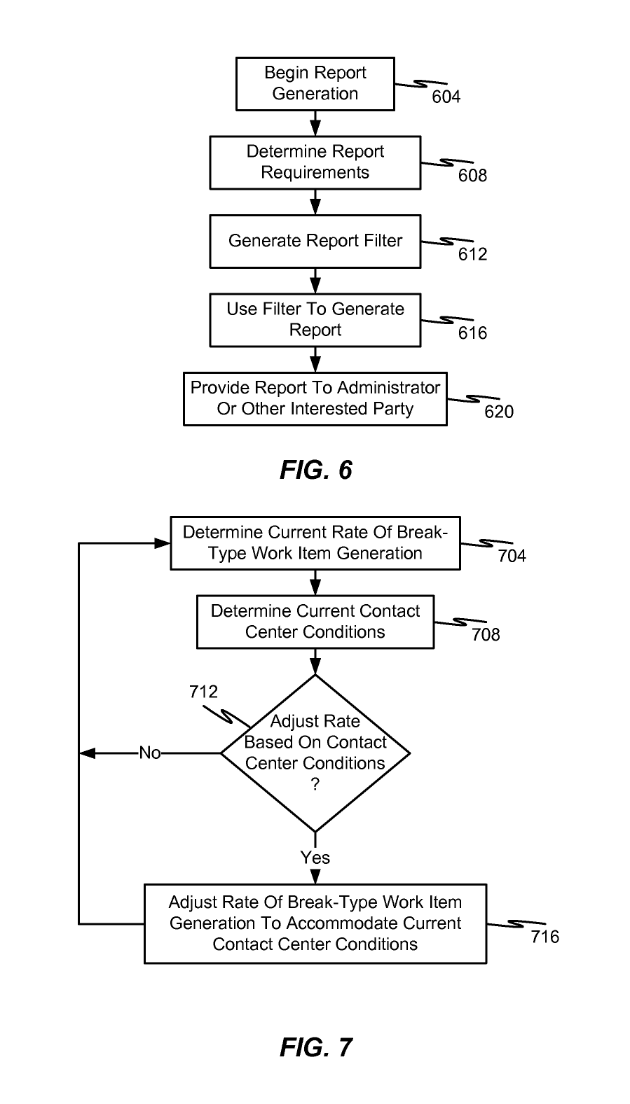

With reference now to FIG. 6, a contact center reporting method will be described in accordance with embodiments of the present disclosure. The method is initiated when it is determined that a report on the contact center operations is to be generated (step 604). This may occur purely based on the passage of time (e.g., daily, weekly, monthly reports may be generated automatically). Alternatively, or in addition, a report generation process may occur in response to receiving a request for a report from one or more interested parties (e.g., manager, agent, system administrator, etc.). It should be appreciated that the report described herein may be requested and/or generated by internal components of the work assignment mechanism 116 or they may be requested by external monitoring engines.

The method continues with the definition of report requirements (step 608). Specifically, the attributes, metrics, performance measures, etc. that are desired for the report may be determined in step 608 and based on the report requirements, one or more report filters may be generated (step 612). The report filters may be applied to some or all reporting data maintained in the various contact center components (e.g., work assignment mechanism 116 may internally track KPIs, service level objectives, union requirements, attributes related thereto, etc.).

In some embodiments, the break-type work may not be reported as starting until all the work completes. For instance, an agent may be multitasking with break work for one media type and actual work for a different media type. The break work may not be reported until the work on the other media type has actually been completed, thereby providing the agent with the ability to complete a multitasking break.

In response to applying the filter(s) against the data in the contact center, the desired report may be generated and provided to the administrator or the interested party that requested the report (step 620). In some embodiments, it may be possible to report on the efficiency with which the contact center is processing traditional work items as well as the efficiency or fairness with which the contact center is distributing break-type work items. Moreover, the reports described herein may be provided to interested parties in various formats (e.g., as reporting documents transmitted by email, SMS message, MMS message, retrievable notifications maintained on a server, RSS feeds, etc.). Furthermore, a single report may contain reporting information for both traditional work items as well as break-type work items. With respect to the reporting of break-type work items, the report may identify whether any particular resource has received an inordinate number of break-type work items, whether certain break requirements are being met, etc.

With reference now to FIG. 7, a method of dynamically adjusting the rate of break-type work item generation will be described in accordance with embodiments of the present disclosure. The method is initiated with the break injector 124, or some other component of the contact center, determining a current rate at which break-type work items 232 are being generated (step 704). The method continues with the break injector 124 determining current contact center conditions (step 708). The current contact center conditions may be determined, at least in part, based on current traffic volume entering the contact center (e.g., whether contacts are entering the contact center at a rate greater or lesser than a predetermined amount), whether one or more service level objectives of the contact center are being met, whether agents are being used as efficiently as possible, etc.

The break injector 124 may have a table stored therein which describes optimal rates for generating break-type work items based on contact center conditions (step 712). Alternatively, or in addition, the table mapping optimal rates to contact center conditions may be stored external to the break injector 124 but may be made available to the break injector 124 as needed or requested. Furthermore, the optimal rates may not necessarily correspond to a rate at which break-type work items 232 in general should be generated, but rather optimal conditions for having a team meeting may be defined.

If the current rate at which break-type work items are generated corresponds to or is at least close enough to the optimal rate for current conditions, then the method will return to step 704. Otherwise, the break injector 124 will dynamically and automatically adjust the rate at which it is generating break-type work items 232 or at least the rate at which certain attributes are given to break-type work items (step 716). Thereafter, the method may return to step 704.

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method, comprising:
generating, by a processor of an electronic communications system, a break-type work item, the break-type work item indicating a break off from work, having one or more attributes that enable a routing decision to be made with respect to routing the break-type work item among a plurality of resources in a contact center;
including the break-type work item in a work pool that includes work items associated with customers;
comparing the one or more attributes of the break-type work item with attributes of the plurality of resources;
selecting, based on the comparing step, a first resource from the plurality of resources to receive the break-type work item;
routing, by the electronic communication system, the break-type work item to the first resource, thereby forcing the first resource to take a break for a predetermined amount of time.

2. The method of claim 1, wherein the one or more attributes define a duration of the predetermined amount of time.

3. The method of claim 1, wherein the first resource is forced to take a break from work items of a first media type but not work items of a second media type.

4. The method of claim 1, wherein the one or more attributes include a team attribute which causes the break-type work item to be routed to at least a second resource at the same time that the break-type work item is routed to the first resource, thereby enabling the first and at least a second resource to take a coordinated break.

5. The method of claim 1, further comprising:
determining a current state of the contact center;
determining a current rate at which break-type work items are being generated and included in the work pool;
determining that the current rate does not correspond to an optimal rate for the current state of the contact center; and
adjusting the rate with which break-type work items are being generated and included in the work pool from the current rate to a second different rate.

6. The method of claim 5, further comprising:
determining reporting requirements for a first report to be generated for the contact center;
generating a report filter based on the reporting requirements;
applying the report filter to work items and break-type work items that are at least one of in the work pool and are currently assigned to a resource in the plurality of resources;
generating a report based on the results of applying the report filter to work items and break-type work items; and
providing the report to at least one interested party.

7. The method of claim 1, wherein the break-type work item comprises a target start and target completion time.

8. The method of claim 1, wherein the break-type work item is assigned to the first resource based on attribute mapping, wherein the first resource, at the time of the attribute mapping, is determined to have attributes that best match the one or more attributes of the break-type work item compared to another resource in the plurality of resources.

9. The method of claim 1, wherein the first resource is an agent operating a communication device and the break-type work item relieves the agent from handling at least one of real-time and near-real-time contacts for the predetermined amount of time.

10. A non-transitory computer readable medium having stored thereon instructions that cause a computing system to execute a method, the instructions comprising:
instructions configured to generate a break-type work item, the break-type work item indicating a break off from work, having one or more attributes that enable a routing decision to be made with respect to routing the break-type work item among a plurality of resources in a contact center;
instructions configured to include the break-type work item in a work pool that includes work items associated with customers;
instructions configured to compare the one or more attributes of the break-type work item with attributes of the plurality of resources;
instructions configured to select a first resource from the plurality of resources to receive the break-type work item; and
instructions configured to route the break-type work item to the first resource, thereby forcing the first resource to take a break for a predetermined amount of time.

11. The computer readable medium of claim 10, wherein the one or more attributes define a duration of the predetermined amount of time.

12. The computer readable medium of claim 10, wherein the first resource is forced to take a break from work items of a first media type but not work items of a second media type.

13. The computer readable medium of claim 10, wherein the one or more attributes include an attribute that defines a desired target for the break-type work item, wherein the attribute that defines the desired target causes the break-type work item to be routed to an agent that has at least one of: recently handled a profitable work item, recently handled a difficult work item, and is scheduled to have a break based on at least one of union and regulatory requirements.

14. The computer readable medium of claim 10, further comprising:
instructions configured to determine a current state of the contact center;
instructions configured to determine a current rate at which break-type work items are being generated and included in the work pool;
instructions configured to determine that the current rate does not correspond to an optimal rate for the current state of the contact center; and
instructions configured to adjust the rate with which break-type work items are being generated and included in the work pool from the current rate to a second different rate.

15. The computer readable medium of claim 14, further comprising:
instructions configured to determine reporting requirements for a first report to be generated for the contact center;
instructions configured to generate a report filter based on the reporting requirements;
instructions configured to apply the report filter to work items and break-type work items that are at least one of in the work pool and are currently assigned to a resource in the plurality of resources;
instructions configured to generate a report based on the results of applying the report filter to work items and break-type work items; and
instructions configured to provide the report to at least one interested party.

16. The computer readable medium of claim 10, wherein the break-type work item comprises a target start and target completion time.

17. The computer readable medium of claim 10, wherein the break-type work item is assigned to the first resource based on attribute mapping, wherein the first resource, at the time of the attribute mapping, is determined to have attributes that best match the one or more attributes of the break-type work item compared to another resource in the plurality of resources.

18. A contact center, comprising:
a processor of the contact center executing a work assignment mechanism including:
a work assignment engine configured to compare attributes of work items in a work pool with attributes of resources in a resource pool and match the work items to resources based on the comparison of attributes; and
a break injector configured to inject break-type work items, ones of the break-type work item indicating a break off from work, into the work pool such that the work assignment engine is allowed to match the break-type work items to resources by comparing attributes of the break-type work items with the attributes of the resources.

19. The contact center of claim 18, wherein the work assignment engine is configured to consider every work item and break-type work item in the work pool every time a resource in the resource pool becomes available.

20. The contact center of claim 18, wherein the break-type work items include one or more attributes that, when assigned to a resource, force the resource to not receive any other work items for a predetermined amount of time.

21. The contact center of claim 18, wherein the break injector is configured to dynamically adjust a rate at which it injects the break-type work items into the work pool based on current contact center conditions.
